(19) United States
(12) Patent Application Publication
(10) Pub. No.: US 2015/0342814 A1
(43) Pub. Date: Dec. 3, 2015

(54) APPARATUS FOR POSITIONING A LEG OF SUPINE PATIENTS FOR SERVICING

(71) Applicant: Victor Terebuh, Granville, OH (US)

(72) Inventor: Victor Terebuh, Granville, OH (US)

(21) Appl. No.: 14/291,102

(22) Filed: May 30, 2014

(51) Int. Cl. A61G 13/12; A61G 13/10

(52) U.S. Cl. CPC A61G 13/1245; A61G 13/10

(57) ABSTRACT

A leg positioning apparatus for improved access to a leg in a supine position includes a base that engages a surface being laid on by a patient. The apparatus further includes a first tube having a first hole on the upper portion of the base. The apparatus further includes a leg holder that engages a leg of the patient. The apparatus further includes a second tube having a second hole on the lower portion of the leg holder. The first and second tubes telescopingly engaging each other to couple the base to the leg holder. The apparatus further includes a pin that engages the first and second holes to couple the first and second tubes to each other.

### TECHNICAL FIELD

The apparatus described herein relates to the field of medicine, more particularly, to the field of ultrasound imaging and nerve blocking.

### BACKGROUND

Anesthesia is a necessary component of modern surgery. Without anesthesia, a surgery can be intolerable or a patient can interfere with the procedure, causing complications. Although local anesthesia is effective in limited procedures, it is not a complete solution, particularly when large areas of the body and multiple tissues are under operation. Another option is rendering the patient unconscious; however, this can also be undesirable because it presents additional hazards to the patient.

For substantial operations on a conscious patient, or in combination with general or sedative anesthesia, regional, or nerve block anesthesia, is often a superior technique. Thanks to high-definition ultrasound technology, precision nerve blocking is now a medical reality. The procedure is undertaken by ultrasound imaging an area of the body that a major nerve passes through in real-time. Once the nerve is located, the practitioner inserts a needle adjacent to the nerve and injects drugs. This will render an entire appendage or area of the body numb for the duration of a procedure.

Nerve blocking is usually performed on certain key locations of the body that are areas that provide convenient access to major nerves proximal to the surgical field. One such location is the popliteal fossa, which is in the back of the knee joint. Easy access to the sciatic nerve is possible at this site and blocking this nerve anesthetizes the back of the knee and the majority of the rest of the leg below the knee. A popliteal fossa sciatic nerve block is typically performed with the patient in a prone or lateral position because it makes the popliteal fossa accessible for the practitioner to position the ultrasound probe. However, turning a patient is undesirable because it is inefficient, often uncomfortable for the patient and it limits monitoring and access to the patients airway should they require support with sedation making it potentially hazardous.

There is a need in the art for a device that enables the performance of a popliteal fossa nerve block with the patient in a supine position.

### BRIEF SUMMARY

A leg positioning apparatus for improved access to a leg in a supine position includes a base that engages a surface being laid on by a patient. The apparatus further includes a first tube having a first hole on the upper portion of the base. The apparatus further includes a leg holder that engages a leg of the patient. The apparatus further includes a second tube having a second hole on the lower portion of the leg holder. The first and second tubes telescopingly engaging each other to couple the base to the leg holder. The apparatus further includes a pin that engages the first and second holes to couple the first and second tubes to each other.

In some embodiments, the apparatus includes a plurality of vertically separated holes on the second tube that allows the leg holder to be coupled to the base at a plurality of heights. In some embodiments, the apparatus includes corresponding holes on either side of the first and second tubes—the pin engages the corresponding holes and is slotted through both sides of the first and second tubes to couple them to each other. In some embodiments, the apparatus includes an ultrasound holder coupled to the base that retains an ultrasound probe on the base. In some embodiments, the apparatus includes a handle coupled to the base that facilitates easy carriage of the apparatus. In some embodiments, the leg holder includes a cushion that engages the leg of the patient.

A leg positioning apparatus for improved access to a leg in a supine position includes a base that engages a surface being laid on by a patient. The apparatus further includes a stand operatively connected to the base that tilts the apparatus relative to the surface. The apparatus further includes a leg holder coupled to the base that engages a leg of the patient.

In some embodiments, the apparatus further includes a hinge that couples the stand to the base and facilitates the rotation of the stand from a stowed position on an upper surface of the base to a lowered position engaging the surface. In some embodiments, the stand includes a foot that engages the surface the base is resting on. In some embodiments, the apparatus includes an ultrasound holder coupled to the base that retains an ultrasound probe on the base. In some embodiments, the apparatus includes a handle coupled to the base that facilitates easy carriage of the apparatus. In some embodiments, the leg holder includes a cushion that engages the leg of the patient.

In some embodiments, the apparatus further includes a first tube having a first hole on the upper portion of the base, a second tube having a second hole on the lower portion of the leg holder with the first and second tubes telescopingly engaging each other to couple the base to the leg holder, and a pin that engages the first and second holes to couple the first and second tubes to each other, with the stand being coupled to a side of the base. In some embodiments, the apparatus further includes a third hole on the second tube positioned at a 90 degree angle from the second hole to allow the stand to be configured in multiple positions relative to the leg holder.

### BRIEF DESCRIPTION OF THE DRAWINGS

FIG. 1 is an angled isometric view from above one embodiment of the apparatus in use.

FIG. 2 is an angled isometric view from above the embodiment shown in FIG. 1.

FIG. 3 is a disassembled angled isometric view from above the embodiment shown in FIG. 1.

FIG. 4 is a front planar view of the embodiment shown in FIG. 1.

FIG. 5 is a side planar view of the embodiment shown in FIG. 1.

FIG. 6 is an angled isometric view from above the embodiment shown in FIG. 1 with the stand in an open position.

FIG. 7 is an angled isometric view from below the leg holder of the embodiment shown in FIG. 1 decoupled from the base.

FIG. 8 is an angled isometric view from below the embodiment shown in FIG. 1 with the leg holder in a lower position.

FIG. 9 is an angled isometric view from below the embodiment shown in FIG. 1 with the leg holder in a middle position.

FIG. 10 is an angled isometric view from below the embodiment shown in FIG. 1 with the leg holder in an upper position.

FIG. 11 is a front planar view of the embodiment shown in FIG. 1 in use with the stand in a stowed position.

FIG. 12 is a front planar view of the embodiment shown in FIG. 1 in use with the stand in a lowered position.

FIG. 13 an angled isometric view from above the embodiment shown in FIG. 1 in use with the stand in a lowered position.

FIG. 14 is an angled isometric view from above the embodiment shown in FIG. 1, with the base mounted to the leg holder in a position with the stand at the foot or thigh end of the leg holder, and with the stand in a lowered position.

### DETAILED DESCRIPTION

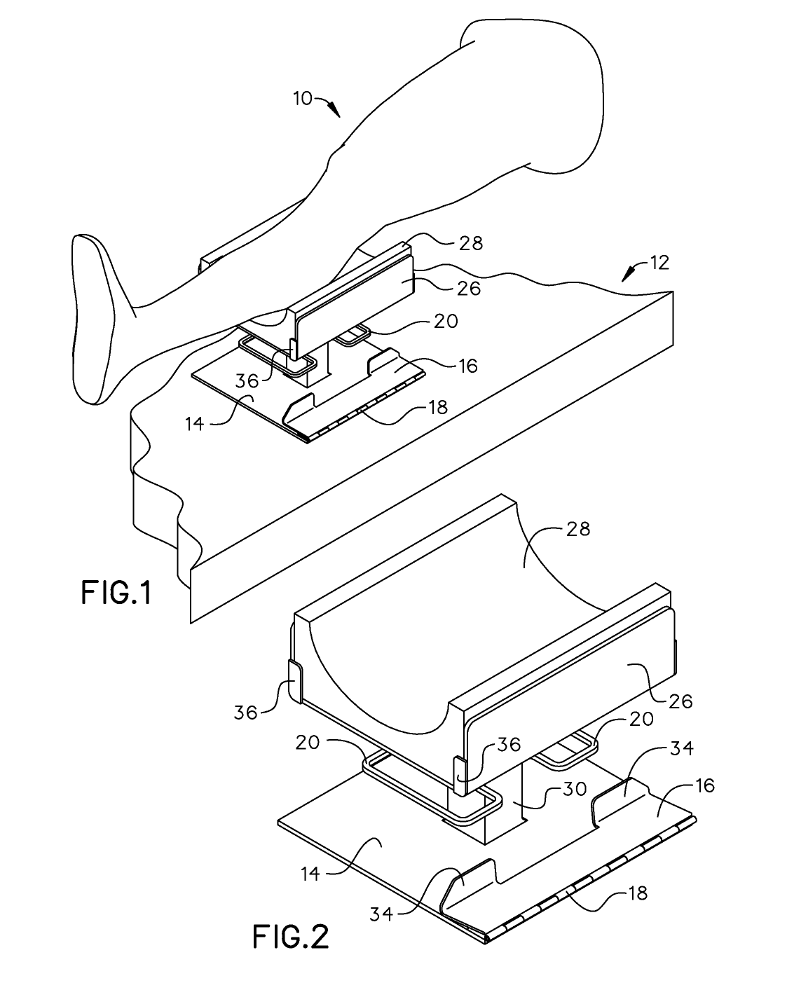

FIG. 1 shows the apparatus according to one embodiment in use. The apparatus rests on a surface 12 on which a patient is laying, such as a hospital bed. The patient is in the supine position, and the apparatus elevates the patient's leg 10 to allow ample access to the popliteal fossa. With the access provided by the apparatus, a practitioner can fit the ultrasound probe and needle necessary for a popliteal fossa sciatic nerve block, and have plenty of room to approach the nerve or image the area at a wide variety of angles, and perform precise needle placement. The elevated leg 12 also places the ankle in an ideal position for injections or operations around its entire circumference.

As can be seen in FIGS. 1 and 2, the apparatus comprises a leg holder 26 coupled to a base 14. Leg holder 26 has a leg cushion 28, which may be easily removed and disposable. Foam retainer plate 36 aids in the retention of cushion 28. Base 14 has a handle 20 for easy transportation of the apparatus. Handle 20 can also function as an ultrasound wand holder to retain an ultrasound wand with the apparatus. Base 14 also has a rotating stand 16 coupled thereto by a hinge 18. Rotating stand 16 has feet 34 that can engage surface 12 in a lowered position. However, in FIGS. 1 and 2, stand 16 is in a stowed position resting against upper surface of base 14. Base 14 further comprises first tube 30 on an upper portion thereof that engages leg holder 26.

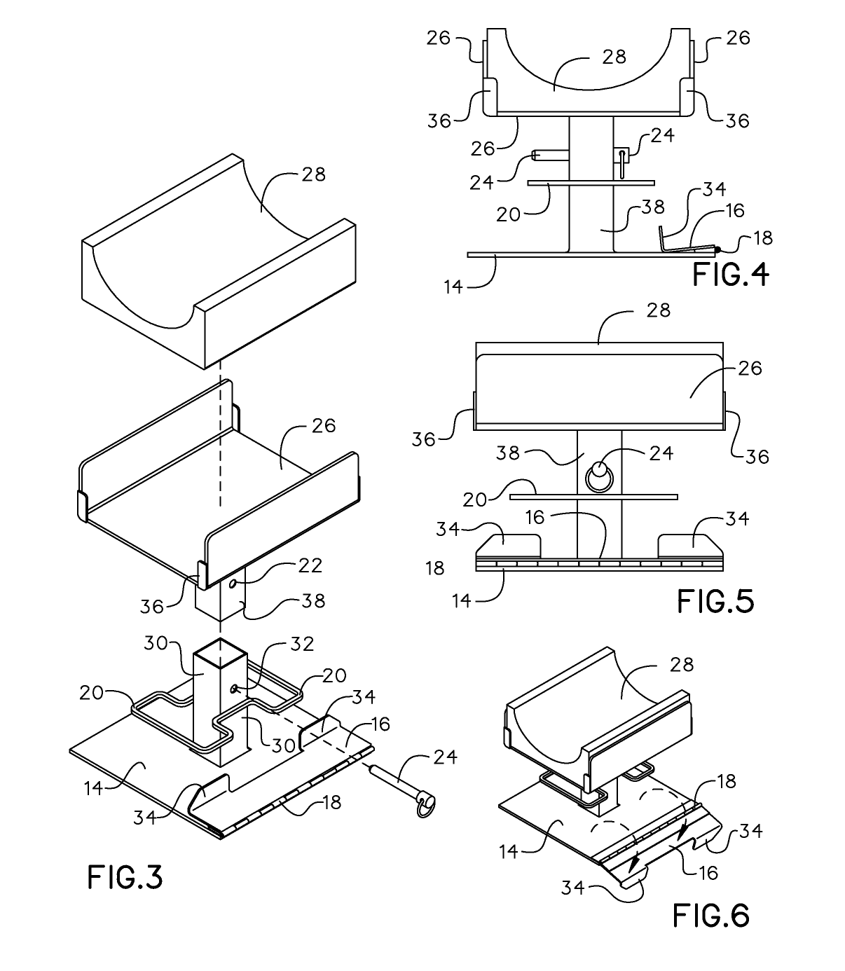

As can be seen in FIGS. 3-5, leg holder 26 is coupled to base 14 by first tube 30 and second tube 38. First and second tubes 30, 38 telescope with each other in order to couple base 14 to leg holder 26. First tube 30 comprises first hole 32, and second tube 38 comprises second hole 22. Pin 24 couples base 14 to leg holder 26 by threading through and engaging first hole 32 and second hole 22. FIG. 4 demonstrates that the tubes 30, 38 may have corresponding holes 22, 32 on either side thereof, so that pin 24 engages both sets of corresponding holes 22, 32 and is threaded through both sides of tubes 30, 38.

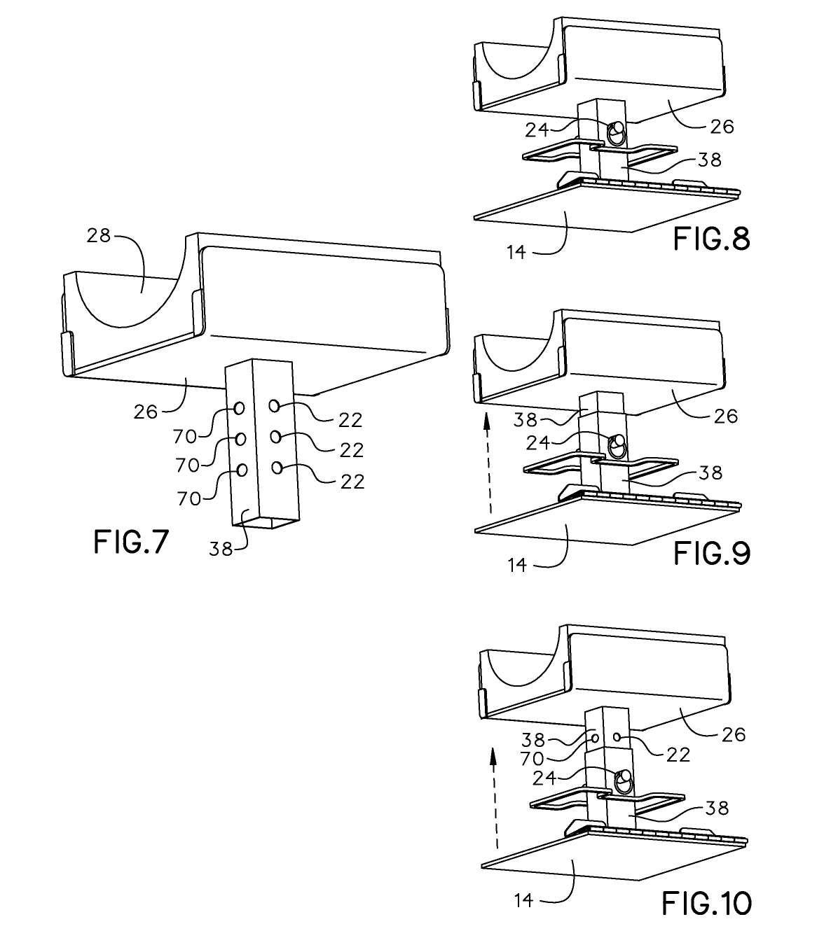

As can be seen in FIGS. 7-10, the height of leg holder 26 can be adjusted relative to base 14. In this embodiment, second tube 38 has multiple vertically separated holes 22 that allow for height adjustment. A set of second holes 22 is aligned with first holes 32 and pin 24 is threaded therethrough at a leg holder 26 height that is desirable to the practitioner. The height of leg holder 26 varies based on which set of vertically separated second holes 22 is aligned with first holes 32 used to engage pin 24. For example, in FIG. 8, leg holder 26 is in a lower position. In FIG. 9, leg holder 26 is in a middle position. In FIG. 10, leg holder 26 is in an upper position. The height of leg holder 26 can be used to adjust the height of the patient's leg 10, either for patient comfort or easier access for the practitioner.

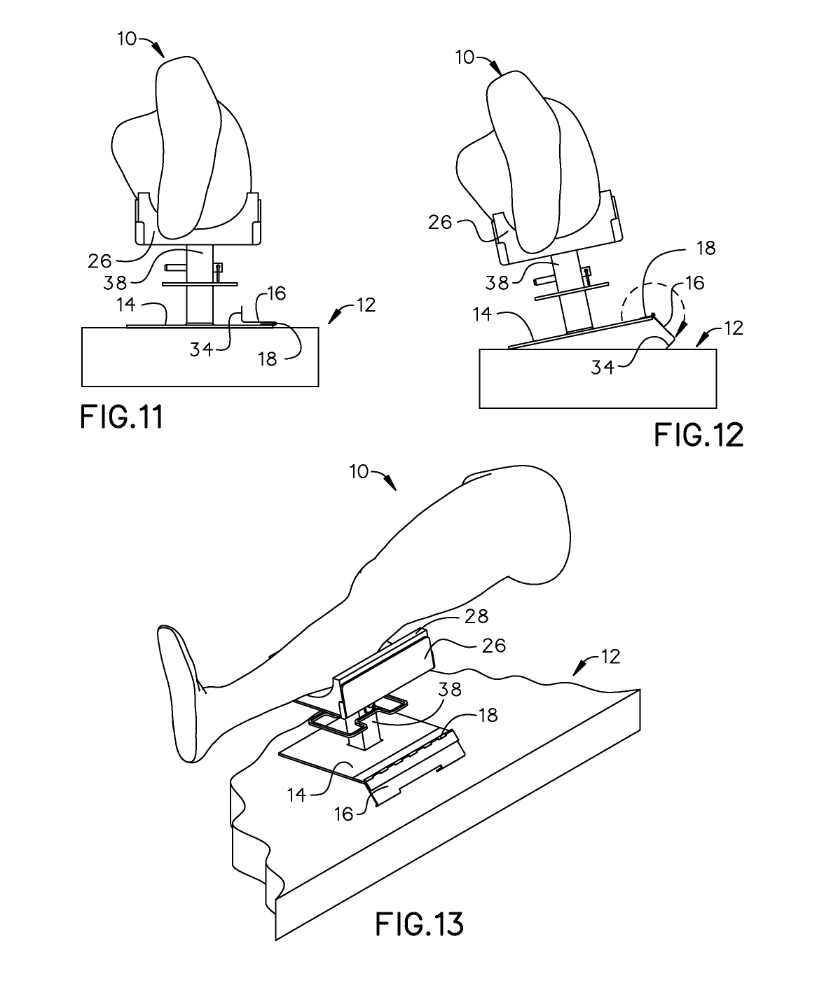

As can be seen in FIGS. 6 and 11-13, stand 16 can be rotated relative to base 14 to tilt the apparatus. In FIG. 11, stand 16 is in a stowed position on an upper surface of base 14. In the stowed position, the vertical axis of the apparatus is perpendicular to surface 12. In FIGS. 6, 12, and 13, stand 16 is in a lowered position and tilts the vertical axis of the apparatus to a non-perpendicular angle relative to surface 12. In this embodiment, the angle is approximately seventy degrees. However, other angles may be preferable, and a fully adjustable stand 16 may be employed in some embodiments to provide a range of tilt angles. Feet 34 on stand 16 give stand 16 better grip on surface 12, which may be pliable and/or uneven, and enhance the stability of the apparatus in a tilted position. The ability to angle leg 10 relative to surface 12 may be advantageous because it increases patient comfort or increases the access available to the practitioner.

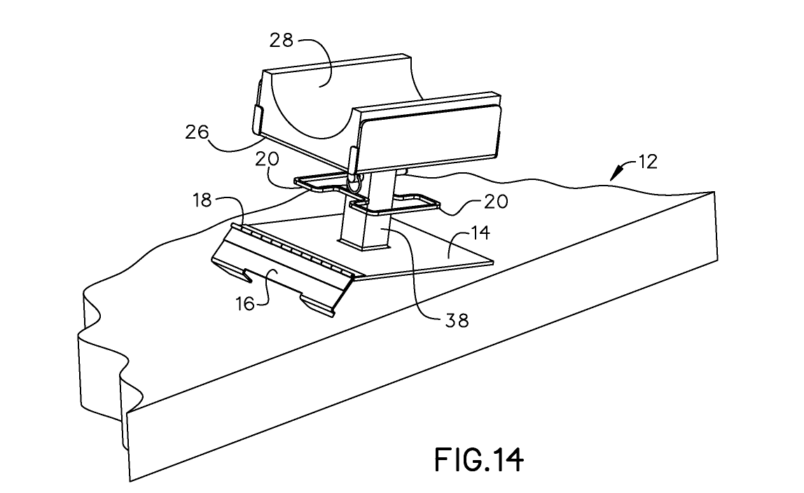

As can be seen in FIGS. 7 and 14, the embodiments shown herein are further adjustable because the position of stand 16 relative to leg holder 26 can be varied. Second tube 38 has a third set of vertically separated holes 70 that allow for height adjustment, and allow base 14 to be mounted to leg holder 26 in four different rotational positions. The third set of holes 70 is positioned at a 90 degree angle relative to the second set of holes 22, on the adjacent face of square tube 38. As can be seen in FIG. 14, this allows for stand 16 to be positioned at the thigh or foot side of leg holder 26, rather than the right or left side. This is particularly advantageous because tilting leg holder 26 from the foot end can elevate the leg without bending the knee which is a desirable position for some practitioners. However, it is also possible to position stand 16 at the thigh side of leg holder 26, if it is desired.

As can be seen by this disclosure, the apparatus described herein enables a practitioner to easily perform a popliteal fossa sciatic nerve block or procedures on the ankle of a patient while the patient remains in a supine position.

Although the invention has been described with reference to embodiments herein, those embodiments do not limit the invention. Modifications to those embodiments or other embodiments may fall within the scope of the invention.

What is claimed is:

1. A leg positioning apparatus for improved access to a leg in a supine position, comprising:
a base that engages a surface being laid on by a patient;
a first tube having a first hole on the upper portion of said base;
a leg holder that engages a leg of the patient;
a second tube having a second hole on the lower portion of said leg holder;
said first and second tubes telescopingly engaging each other to couple said base to said leg holder; and
a pin that engages the first and second holes to couple said first and second tubes to each other.

2. The apparatus of claim 1, further comprising:
a plurality of vertically separated holes on said second tube that allows said leg holder to be coupled to said base at a plurality of heights.

3. The apparatus of claim 1, further comprising:
corresponding holes on either side of said first and second tubes;
wherein said pin engages said corresponding holes and is slotted through both sides of said first and second tubes to couple them to each other.

4. The apparatus of claim 1, further comprising:
an ultrasound holder coupled to said base that retains an ultrasound probe on said base.

5. The apparatus of claim 1, further comprising:
a handle coupled to said base that facilitates easy carriage of the apparatus.

6. The apparatus of claim 1, wherein said leg holder comprises a cushion that engages the leg of the patient.

7. A leg positioning apparatus for improved access to a leg in a supine position, comprising:
a base that engages a surface being laid on by a patient;
a stand operatively connected to said base that tilts the apparatus relative to the surface; and
a leg holder coupled to said base that engages a leg of the patient.

8. The apparatus of claim 7, further comprising:
a hinge that couples said stand to said base and facilitates the rotation of said stand from a stowed position on an upper surface of said base to a lowered position engaging the surface.

9. The apparatus of claim 7, wherein said stand comprises a foot that engages the surface said base is resting on.

10. The apparatus of claim 7, further comprising:
an ultrasound holder coupled to said base that retains an ultrasound probe to said base.

11. The apparatus of claim 7, further comprising:
a handle coupled to said base that facilitates easy carriage of the apparatus.

12. The apparatus of claim 7, wherein said leg holder comprises a cushion that engages the leg of the patient.

13. The apparatus of claim 7, further comprising:
a first tube having a first hole on the upper portion of said base;
a second tube having a second hole on the lower portion of said leg holder;
said first and second tubes telescopingly engaging each other to couple said base to said leg holder; and
a pin that engages the first and second holes to couple said first and second tubes to each other;
wherein said stand is coupled to a side of said base.

14. The apparatus of claim 13, further comprising:
a third hole on said second tube positioned at a 90 degree angle from the second hole to allow said stand to be configured in multiple positions relative to said leg holder.
